(19) United States
(12) Patent Application Publication
(10) Pub. No.: US 2009/0057332 A1
(43) Pub. Date: Mar. 5, 2009

(54) Food container having separate refuse disposal receptacle

(76) Inventor: Emma Arzola, Tulare, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/229,989

(22) Filed: Aug. 27, 2008

Related U.S. Application Data
(60) Provisional application No. 60/966,753, filed on Aug. 28, 2007.

(51) Int. Cl. G07F 11/04

(52) U.S. Cl. 221/102

(57) ABSTRACT

A food container configured for use with food products having a refuse component, such as sunflower and other products having shells and fruit or other products having nonedible seeds or pits. The food container comprises a lower receptacle having a chamber configured to store a quantity of food product, an upper receptacle having a chamber configured to receive and store the refuse, a dispensing mechanism at a dispensing opening in the lower receptacle for dispensing the food product therefrom and a lid at the upper receptacle for enclosing the refuse. In a preferred embodiment, the lower end of the upper receptacle is removably received in an opening at the upper end of the lower receptacle and connected thereto to form a single food container unit. The dispensing mechanism can be a openable tab member or a rotatable dispensing member having an outlet aperture that is aligned with the dispensing opening.

### CROSS-REFERENCE TO RELATED APPLICATIONS

This application claims the benefit of U.S. Provisional Patent Application No. 60/966,753 filed Aug. 28, 2007.

### BACKGROUND OF THE INVENTION

A. Field of the Invention

The field of the present invention relates generally to the packaging of foods in containers from which the food is eaten. More particularly, the present invention relates to the packaging and serving of foods that have a portion which is eaten by the consumer and a portion which the consumer disposes as refuse, such as sunflower seeds, nuts and the like. Even more particularly the present invention relates to the packaging and serving of such foods in a single container that has an area which stores the uneaten food and an area which receives the refuse portion of the food.

B. Background

Many people enjoy eating snack type foods while they watch or participate in an activity, including watching sporting events such as a baseball, basketball, football and soccer games or horse and automobile racing, watching a movie or television, driving or riding in a vehicle, or just relaxing by the pool or on the beach. Many of these snack types of foods have an edible portion that is eaten by the consumer and a refuse portion, which typically encloses the edible portion, that is not eaten and must be disposed of by the consumer. Hereinafter, such types of foods are referred to as “food products,” the generally edible portion is referred to as the “edible portion” and the refuse portion is referred to as “food-related refuse” or “refuse”. Examples of such food products include various nuts, seeds and fruits, including peanuts, pistachios, sunflower seeds, pumpkin seeds, olives and cherries. The food-related refuse associated with these food products include shells and seeds. With regard to these and related food products, the consumer must either first break open the shell to get to the edible inner portion of the food product, as with nuts and sunflower seeds for example, or eat through the edible portion to the seed at the center thereof, as with olives and cherries for example. As well known to those familiar with these food products, whether they enjoy eating them or they have to clean up after others who enjoy eating the food products, the primary negative aspect of these types of food products is that the food-related refuse can result in a significant amount of debris which must be disposed of by the consumer.

Although sunflower seeds and other types of food products are occasionally provided in plastic cups and cardboard boxes, packaging for the food products typically comprises a quantity of individual items of the food product packaged in a plastic bag, paper sack or like packaging. The consumer usually removes one or more of the individual food products from the package of food products for consumption. Once the consumer removes the outer shell or eats the edible portion, he or she is left with the food-related refuse for disposal. If the consumer is eating the food product at home, he or she generally has a trash can or other trash receptacle readily available, meaning at or near the person's location, for receiving the food-related refuse. However, if the consumer is eating the food products at a sporting event or is outside of the home, such trash receptacles are usually not readily available. As a result, the consumer of these food products typically disposes the food-related refuse in a manner that is most convenient to him or her. While some people are diligent about placing the food-related refuse into a container of some type that can then be transferred to a trash receptacle, many people tend to just dispose the refuse on the ground near where they are sitting or standing. This is particularly true of the small, shelled food products such as sunflower seeds, pumpkin seeds and nuts, and those food products with small seeds, such as cherries. Some of these, particularly the sunflower and pumpkin seed products, tend to be spit out by the consumer after he or she has separated the shell from the edible portion in his or her mouth. As many people have seen, the consumption of food products can result in a large amount of food-related refuse laying on the ground, floor or other surface around the person eating the food product. For instance, it is common to see a rather larger pile of sunflower seed shells at a baseball game or other sporting event where a fan or player was sitting and consuming such food product.

One of the problems with the above food products is that they are usually packaged and served to the consumer in a single container that holds the uneaten food product with, generally, no real concern given to where the person is to dispose of the naturally occurring food-related refuse associated with the food product. Typically, the package is not configured for the consumer to place the refuse in the same container as the food product. In fact, because the typical container for such food products is an open bag or sack, placing the refuse in the container would only create a mess around the uneaten food product, be very inconvenient for the consumer to remove additional food product from the container and not be very hygienic, particularly if such food product is being shared. As a result, the consumer is typically left to fend for himself or herself with regard to the disposal of food-related refuse. Those persons who do not choose to drop or spit out the refuse onto the ground generally obtain an empty cup, can, bag or sack in which to dispose of the food-related refuse. In fact, it is common for such a person to grab an empty soda or beer cup or can, whether it is theirs or not, to be able to drop or spit the refuse into. Use of cups, cans or the like that were previously utilized for drinks, particularly if they belong to others and/or are not completely empty, can create further mess, time-consuming and hygiene issues.

One example of a product that is the result of some thought into the consumer's need to dispose of the food-related refuse when consuming food products is the David® sunflower seed “Travel Cup” product by ConAgra Foods, Inc. This product packaging comprises a bag of sunflower seeds disposed inside a plastic cup. The intent appears to be that someone removes the bag of seeds from the plastic cup and then spits or otherwise disposes the food-related refuse inside the cup (hence the Spit Responsibly™ slogan). Although the product does provide the consumer with a readily available cup for disposal of the refuse, thus eliminating the need to seek out a cup, the product does require the consumer to handle and manipulate two separate containers, one containing sunflower seeds and one for the refuse, while simultaneously retrieving seeds from the bag and disposing them (typically by spitting) into the cup. The cup and its contents are then disposed of or the cup is emptied and then cleaned for reuse.

Over the years, multiple use containers have been developed to package and serve food, beverage or other items to the consumer. For instance, U.S. Pat. No. 6,060,097 to Grigoryan discloses a food cup comprising an elongated cardboard outer cylinder in which is disposed, at the lower end thereof, an inner cylinder open at both ends. A mouth opens in the lower part of the outer container and food passes from the inner container past teeth which limit the flow of food. A waste cup is placed inside the upper part of the outer container. In use, the waste cup moves down the outer container chamber as food is removed through the mouth and waste is placed in the waste cup. A beverage cup can be placed in the top cover of the outer container. U.S. Pat. No. 5,664,671 to Nedblake, Jr. describes a combination container comprising a first container having a beverage and a second container, at the base of the first container, having an edible solid. A band of heat-shrunk material surrounds the containers on either side of where they abut for coupling the two containers together. U.S. Pat. No. 6,989,168 to Fahey describes a dual compartment beverage container for dispensing a single serving of beverage and snack food. The container wall is configured to define two product containment regions, a recess for receiving a cartridge containing food and a compartment for containing a beverage. U.S. Pat. No. 5,881,868 to Soyak, et al. describes a container for liquid and tobacco products that is configured as a bottle for the liquid with a recess area disposed in the bottle and open at the bottom to receive cigars. A seal closes the opening to keep the cigars fresh and humidified.

Except for the patent to Grigoryan, none of the foregoing prior art devices provides a food container suitable for use with a food product having a food-related refuse associated therewith. The food cup of Grigoryan appears to be somewhat inconvenient for use in most situations where the user would desire to consume such food products. What is needed, therefore, is an improved food container that packages a food product for serving to the consumer and provides the consumer with an easy to use, convenient disposal area for receiving the food-related refuse. The preferred food container will have an area that stores the food product for consumption, a controllable opening configured to selectively dispense a portion of the food product from the container and a separate area that easily and conveniently receives the food-related refuse. Preferably, the food container is configured so the user does not have to hold and manipulate multiple packages while he or she retrieves food product from the container and disposes the food-related refuse therein. The preferred food container will be made out of materials that results in a lightweight, versatile and relatively inexpensive to manufacture packaging system that is readily disposable and recyclable/biodegradable.

### SUMMARY OF THE INVENTION

The food container having a separate refuse disposal receptacle of the present invention solves the problems and provides the benefits identified above. That is to say, the present invention discloses an improved food container that provides a packaging system which stores a food product for consumption and provides a convenient and easy to utilize receptacle for receiving the food-related refuse. In a preferred embodiment of the present invention, the food container is adaptable for use with a wide variety of food products that have an edible portion and refuse portion associated therewith, including nuts, seeds and fruit that have shells or seeds that covers or is covered by the edible portion of the food product. The preferred embodiment of the food container of the present invention has a closed area for storing the food product until it is ready for consumption, a controlled opening that allows the user to selectively dispense a desired quantity of food product from the food storage area of the container and a separate, closeable receptacle for receiving food-related refuse, from which the refuse may be disposed. The food container of the present invention provides an easy to use food packaging and serving system that allows the user to dispense a selected quantity of food product and dispose of the food-related refuse in a sanitary and non-littering manner without having to manipulate multiple packages or containers. The present food container can be made out of a variety of materials, including those that provide a lightweight, versatile and inexpensive to manufacture food container which is itself disposable and recyclable. In use, the food container of the present invention provides improved consumer convenience and functionality with regard to the packaging and serving of food products having an edible portion and a separate refuse portion. The food product storage area of the present container is closed to maintain the freshness of the food product while providing a receptacle that makes it is easier to eat the food product in a neat and clean manner without having to obtain a separate disposal receptacle.

In one general aspect of the present invention, the food container having a separate refuse disposal receptacle generally comprises an upper receptacle, a lower receptacle, a dispensing opening in the lower receptacle, a dispensing mechanism at the dispensing opening and a lid at the upper end of the upper receptacle. The upper receptacle has one or more side walls and a bottom wall that define an upper chamber between the upper end and a lower end of the upper receptacle. The upper chamber is sized and configured to receive food-related refuse therein. The upper end of the upper receptacle is substantially open to allow access to the upper chamber so the user can place or spit the refuse into the upper receptacle. The bottom wall of the upper receptacle closes the lower end of the upper receptacle. The lower receptacle has one or more side walls and a bottom wall that define a lower chamber between an upper end and a lower end of the lower receptacle. The bottom wall closes the lower end of the lower receptacle. The lower chamber is sized and configured to store a quantity of food product therein. The lower end of the upper receptacle is received in the upper end of the lower receptacle. In a preferred embodiment, the upper receptacle is removably received in the lower receptacle. Preferably, the dispensing opening, which is sized and configured to allow the food product to pass therethrough, is disposed in one of the side walls of the lower receptacle. The dispensing mechanism is located at the dispensing opening and configured to selectively dispense food product from the lower receptacle through the dispensing opening. The lid is removably attached to the upper end of the upper chamber to selectively enclose the refuse in the upper receptacle. In a preferred embodiment, the lid is hingedly attached to the side wall of the upper receptacle. In an alternative embodiment, the lid is threadably attached. In one embodiment, the opening at the upper end of the lower receptacle is sized and configured to tightly receive and engage the lower end of the upper receptacle. In the preferred embodiment, the food container has a connecting mechanism, which can be correspondingly configured threads, that connects the lower end of the upper receptacle to the upper end of the lower receptacle. In use, the manufacturer or a user fills the lower receptacle with food product. The user then opens the dispensing mechanism to dispense food product from the chamber of the lower receptacle through the dispensing opening. After removing the refuse portion of the food product from the edible portion, the user disposes the refuse in the chamber of the upper receptacle. The lid is used to close the refuse inside the upper receptacle. In one embodiment, the lower receptacle can be refilled with food product and the refuse can be emptied from the upper receptacle. In another embodiment, when the food product in the container is fully consumed, the consumer can dispose of the entire food container, including the food-related refuse, or place it in a recycling receptacle.

Accordingly, the primary objective of the present invention is to provide an improved food container for use with food products that provides the advantages discussed above and overcomes the disadvantages and limitations associated with presently available food containers and packaging systems for such food products.

It is also an important object of the present invention to provide a food container that packages a food product for serving to the consumer and provides an easy to use and convenient receptacle for receiving the food-related refuse associated with the food product.

It is also an important object of the present invention to provide a food container for use with food products having an edible portion and a refuse portion that provides a closed area for serving the food product, a controllable opening for dispensing a desired quantity of food product from the closed area and a receptacle for receiving the food-related refuse.

It is also an important object of the present invention to provide a food container that does not require the consumer to handle multiple packages while trying to remove a quantity of food product from one of the packages and dispose of the food-related refuse in a separate container.

It is also an important object of the present invention to provide a food container that comprises a first or lower receptacle that stores a quantity of food product, a second or upper receptacle that has a closed lower end that is received in and cooperatively engaged with an opening at the upper end of the lower receptacle and an open upper end for receiving food-related refuse therein, a mechanism for dispensing food product from the lower receptacle and a lid for closing the opening at the upper end of the upper receptacle to enclose the refuse inside the container to allow the user to selectively dispense a desired quantity of food product and conveniently and cleanly dispose of the food-related refuse.

It is also an object of the present invention to provide a food container having the above and other packaging/serving features that is lightweight, adaptable to a variety of food products, relatively inexpensive to manufacture and disposable.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a food container configured according to a preferred embodiment of the present invention showing a dispensing mechanism for dispensing food product from the lower receptacle and a lid enclosing refuse in the upper receptacle;

FIG. 2 is a side view of the lower receptacle of the food container shown in FIG. 1;

FIG. 3 is a side view of the upper receptacle of the food container of FIG. 1 shown with the lid in its removed or open position;

FIG. 4 is a side view of the food container of FIG. 1 shown with the dispensing mechanism in the open position dispensing food product from the lower receptacle and the lid in the open position receiving food-related refuse into the upper receptacle;

FIG. 5 is a side view of an alternative embodiment of the food container of the present invention shown with the dispensing mechanism in the closed position and the lid secured to the upper receptacle; and

FIG. 6 is a side view of the food container of FIG. 5 shown with the dispensing mechanism in the open position to dispense food product from the lower receptacle and the lid removed from the upper receptacle to receive refuse therein.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily described as being utilized with food products having shells or seeds, those skilled in the art will readily understand that this is merely for purposes of simplifying the present disclosure and that the present invention is not so limited. For instance, the present invention is equally applicable for use with other foods, such as individually wrapped snacks and/or candies.

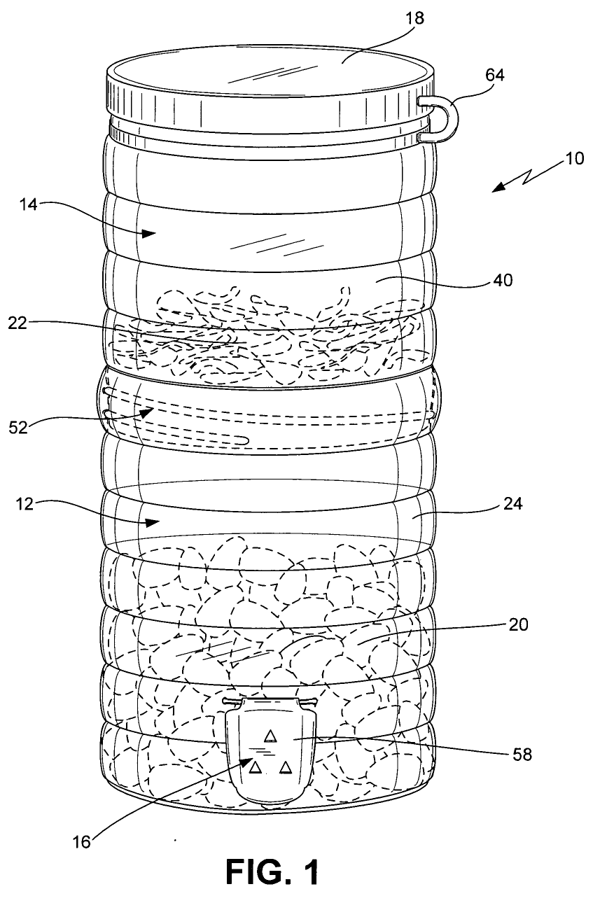

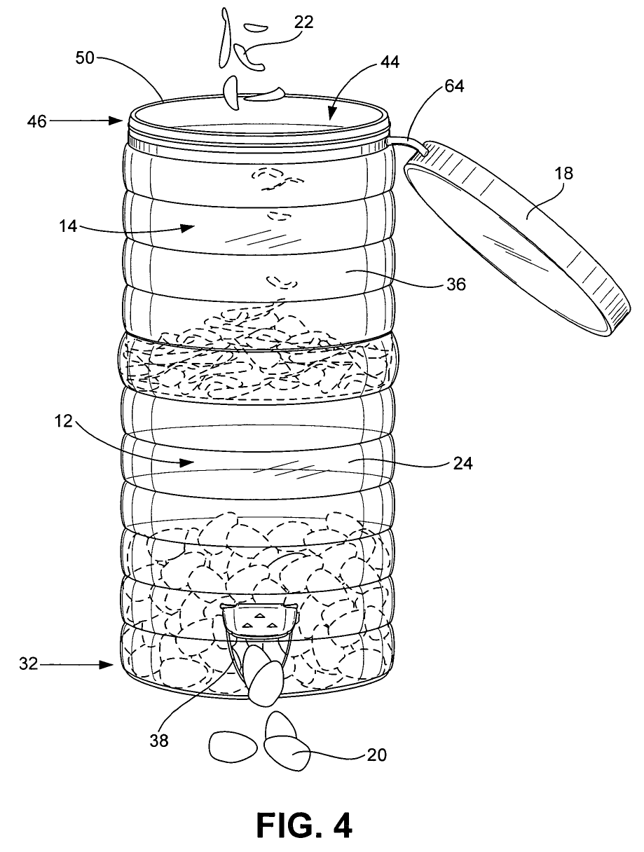

A food container that is manufactured out of the components and configured pursuant to a preferred embodiment of the present invention is shown generally as 10 in FIGS. 1 and 4. As shown in the accompanying figures, food container 10 primarily comprises a first or lower receptacle 12, a second or upper receptacle 14, a dispensing mechanism 16 and a lid 18 that, as set forth in more detail below, are configured to cooperate together to provide a packaging and serving system for food products 20 that also provides a convenient place to dispose of the food-related refuse 22. As set forth in more detail below, a portion of the upper receptacle 14 is received in a portion of the lower receptacle 12 to enclose the food product 20 in lower receptacle 12, the dispensing mechanism 16 is operated to dispense the food product 20 from the lower receptacle 12, the lid 18 is removed from the upper receptacle 14 so the user may place food-related refuse 22 inside the upper receptacle 14 and the lid 18 is placed on the upper receptacle 14 to enclose the food-related refuse 22 inside the upper receptacle 14. If desired, non-food related refuse or debris may also be disposed in upper receptacle 14. Typically, the user will hold food container 10 in one hand and then tilt it to pour or shake out a desired quantity of food product 20 onto his or her other hand, from which at least the edible portion is transferred to the mouth for consumption, or a portion of the food product 20 will be poured directly into the user's mouth by tipping food container 10 with the dispensing mechanism 16 at the mouth. The food-related refuse 22, after being separated from the edible portion of the food product 20, is disposed in the upper receptacle 14 by hand or from the user's mouth (i.e., spitting).

Although lower receptacle 12 and upper receptacle 14 of container 10 can be made from a wide variety of materials, it is preferred that the selected materials be lightweight, easy to grip, disposable and suitable for recycling. An example of such material is molded plastic, pulp, paper, cardboard or any combination thereof. Alternatively, container 10 may be made out of aluminum, other lightweight metals or various composites. Container 10 can be provided as a single use item that has a fixed quantity of food product 20 in lower receptacle 12, that receives the refuse 22 therefrom in the upper receptacle 14 and then the entire container, having an empty lower receptacle 12 and a refuse-filled upper receptacle 14, is disposed. Alternatively, the user can reuse container 10 by refilling the lower receptacle 12 with food product 20 and by emptying the refuse 22 in upper receptacle 14 into a separate trash receptacle.

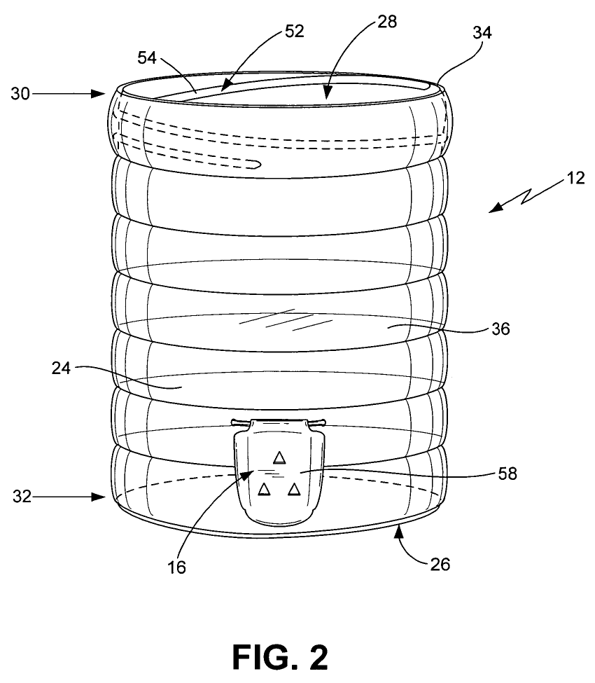

Lower receptacle 12 has, depending on its configuration, one or more side walls 24 and a bottom wall 26 that define a lower chamber 28 that is substantially open at the upper end 30 of lower receptacle 12 and closed at the lower end 32 of lower receptacle 12 to form a cup-like configuration, as best shown in FIG. 2. The lower chamber 28 is sized and configured to receive a quantity of food product 20 therein through the opening 34 into lower chamber 28 and store such food product 20 until ready for consumption by the user. As will be readily appreciated by those skilled in the art, although lower receptacle 12 is shown in a generally cylindrical shape, it can be formed in a variety of different configurations, including rectangular, square, triangular or the like. Preferably, the dimensions of lower receptacle 12 are such that it will be easy for the user to grasp and manipulate with only one hand. As shown in the figures, side wall 24 can be shaped and configured to make it easier for the user to grasp and for aesthetic purposes, such as having a plurality of looped ridges 36. Because the lower receptacle 12 will receive at least the lower portion of upper receptacle 14 through the opening 34 and the two receptacles 12/14 will engage each other, at least the engaging portions of the lower 12 and upper 14 receptacles must be cooperatively sized and configured.

As best shown in FIG. 4, lower receptacle 12 has a dispensing opening 38 that is beneficially positioned for dispensing food product 20 from lower chamber 28. In a preferred embodiment, dispensing opening 38 is located at the lower end 32 of lower receptacle 12, typically on side wall 24 at or near where side wall 24 intersects with bottom wall 26, so that it will be easy for the user to completely dispense the food product 20 from lower chamber 28 so that none of the food product 20 is left behind in lower chamber 28. Alternatively, dispensing opening 38 can be positioned on bottom wall 26, which is also easy for completely emptying lower chamber 28, or elsewhere on side wall 24 (such as toward upper end 30). Dispensing opening 38 should be sized and configured so food product 20 can relatively easily pass so the user can dispense food product 20 to his or her hand or mouth without substantial clogging. Naturally, different sizes of food product 20, such as sunflower seeds versus cherries, will require different sizes and configurations of dispensing opening 38.

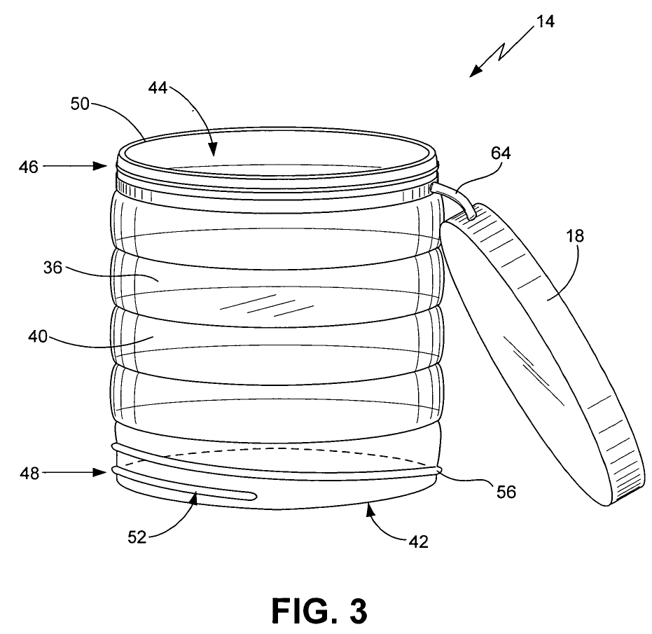

Upper receptacle 14 has, depending on its configuration, one or more side walls 40 and a bottom wall 42 that define an upper chamber 44 that is substantially open at the upper end 46 of upper receptacle 14 and closed at the lower end 48 of upper receptacle 14 to form a cup-like configuration, as best shown in FIG. 3. The upper chamber 44 is sized and configured to receive the food-related refuse 22 from food product 20 therein through the opening 50 into upper chamber 44 and store such refuse 22 for later disposal, which can be by emptying upper chamber 44 into a trash receptacle or by disposing of the entire container 10. As will be readily appreciated by those skilled in the art, although upper receptacle 14 is shown in a generally cylindrical shape, it can be formed in a variety of different configurations, including rectangular, square, triangular or the like. The dimensions of at least the lower end 48 of upper receptacle 14 must be sized and configured to fit within the opening 34 at the upper end 30 of lower receptacle 12. Preferably, the dimensions of upper receptacle 12 are generally consistent from its lower end 48 to its upper end 46 and are such that it will be easy for the user to grasp and manipulate with only one hand. As shown in the figures, side wall 40 can be shaped and configured to make it easier for the user to grasp and for aesthetic purposes, such as having a plurality of looped ridges 36 (as with lower receptacle 12). As stated above, because lower receptacle 12 will receive at least the portion of upper receptacle 14 at or near its lower end 48 through the opening 34 such that the two receptacles 12/14 engage each other, at least the engaging portions of the lower 12 and upper 14 receptacles must be cooperatively sized and configured. Preferably, the lower 12 and upper 14 receptacles are at least generally shaped the same.

As stated above, the lower 12 and upper 14 receptacles can be made out of a variety of different materials. In one preferred configuration, the two receptacle 12/14 are made out of plastic, such as that which is utilized for water bottles and soda bottles. The lower receptacle 12 can be made out of a transparent plastic material so the user can see the food product 20 inside lower chamber 28. This has an advantage from a marketing standpoint in that it allows the manufacturer to better display its food product 20 in order to entice the buyer into purchasing the container 10 and an advantage from a user standpoint in that it allows the user to readily determine the type of food product 20 and how much food product 20 is inside lower chamber 28. In the preferred embodiment, the upper receptacle 14 is sufficiently colored such that it is at least partially opaque, if not completely opaque, so that the food-related refuse 22 in upper chamber 44, which is typically not an attractive sight, is not easily seen from outside container 10 and to readily distinguish upper receptacle 14 from lower receptacle 12. In addition, or as an alternative, the outer surface of side wall 24 of upper receptacle 14 can be at least substantially covered with a label, such as the company label or trademark, to essentially hide the food-related refuse 22 which is stored inside upper chamber 44.

The food container 10 of the present invention comprises a means for connecting the lower 12 and upper 14 receptacles, referred to herein as the connecting mechanism 52, to form a single unit. In one embodiment, the two receptacles 12/14 are cooperatively sized and configured such that the lower end 48 of upper receptacle 14 tightly fits into and engages the opening 34 at the upper end 30 of lower receptacle 12. In this manner, the manufacturer and the user only need to insert the lower end 48 of upper receptacle 14 through the opening 34 at the upper end 30 of lower receptacle 14 to join the two receptacles 12/14 together. Once joined, the opening 34 of lower receptacle 14 should be substantially sealed so as to maintain the freshness of the food product 20 stored inside lower chamber 28. Alternatively, a variety of different types of connecting mechanisms 52 can be utilized with food container 10 of the present invention. In a preferred embodiment, the connecting mechanism 52 comprises a set of first threads 54 at the upper end 30 of lower receptacle 12 inside lower chamber 28 and a cooperatively configured set of second threads 56 at the lower end 48 of upper receptacle on the outside of side wall 40 such that the two receptacles 12/14 are threadably connected with upper receptacle 14 threadably received inside lower receptacle 12, as shown in FIGS. 1 through 4. In this configuration, the user twists upper receptacle 14 relative to lower receptacle 12 to allow access to the lower chamber 28 through opening 34 so that he or she may then refill lower chamber with food product 20. Various other forms of twist-off connectors can be utilized with food container 10. In addition, various configurations of snap connectors or the like may also be used to connect receptacles 12 and 14.

As set forth above, in the preferred embodiment of food container 10 of the present invention the receptacles 12 and 14 are removably connected to each other so that the user may pull the upper receptacle 14 out of the lower receptacle 12 to refill lower chamber 28 with food product 20 or replace the food product 20 in lower receptacle 12 with another type of food product 20. An additional benefit of this type of configuration is that the food container 10 can be sold without any food product 20 inside lower receptacle 12. The food container 10 could be manufactured and sold as a unit for people to purchase and add their own food product 20. In an alternative embodiment, receptacles 12 and 14 may be fixedly joined together, with the lower end 48 of upper receptacle 14 fixedly attached to the upper end 30 of lower receptacle 12 through opening 34. In this embodiment, food container 10 would be provided with a fixed amount of food product 20 inside lower chamber 28 and the user would dispose of the food container 10 after he or she eats all the food product 20.

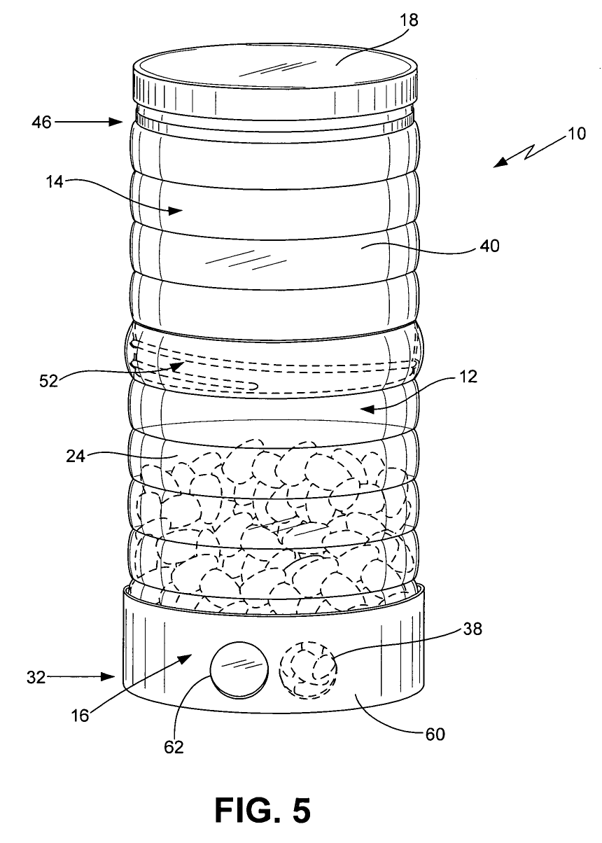

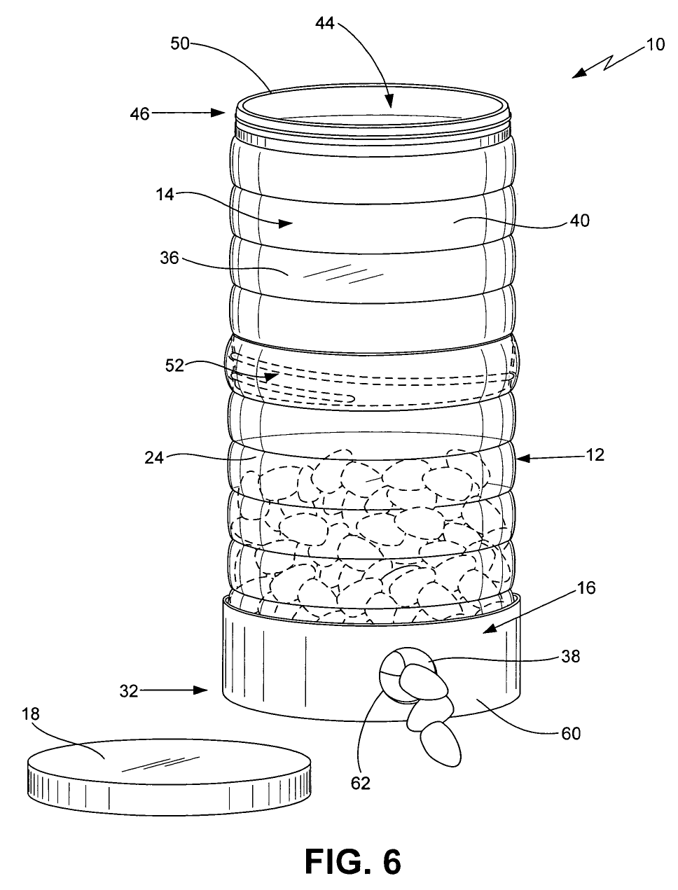

The dispensing mechanism 16 is configured to selectively close and open the dispensing opening 38, through which food product 20 is dispensed to the user. When in the closed position, food product 20 should be prevented from exiting lower chamber 28. In one embodiment, shown in FIGS. 1, 2 and 4, the dispensing mechanism 16 is a tab member 58 that is pivotally attached to side wall 24 of lower receptacle 12 such that the user pivots the tab member 58 upward, typically using a finger tip or fingernail, to open the dispensing opening 38 and allow food product 20 to exit lower receptacle 12, as shown in FIG. 4. An example of such dispensing mechanisms 16 can be found in containers of salt and like products. Naturally, if dispensing opening 38 is located elsewhere on lower receptacle 12, then the dispensing mechanism 16 should be located at that same location. An alternative configuration for dispensing mechanism 16 is shown in FIGS. 5 and 6. In this configuration, the dispensing mechanism 16 comprises a dispensing member 60, which is rotatably disposed relative to the lower end 32 of lower receptacle 12, having an outlet aperture 62 that is kept out of alignment with dispensing opening 38 to prevent food product 10 from exiting food container 10, as shown in FIG. 5, and placed in alignment with dispensing opening 38 to dispense food product from food container 10, as shown in FIG. 6. In one of the preferred embodiments, dispensing member 60 is rotatably attached to the bottom wall 26 of lower receptacle 12 using a pin or like member (not shown) about which the dispensing member 60 rotates. In another embodiment, the outer surface of side wall 24 at or near the lower end 32 of lower receptacle 12 is cooperatively configured with the inside surface of dispensing member 60 such that dispensing member 60 can rotate at least a sufficient distance around lower receptacle 12 to align and unalign dispensing opening 38 and outlet aperture 62 to allow or prevent food product 20 from exiting lower receptacle 12. In any configuration of dispensing mechanism 16, the dispensing mechanism should be configured to prevent accidental opening of dispensing mechanism 16 and be configured to substantially seal lower chamber 28 so as to help keep the food product 20 therein fresh.

To allow the user to dispose of the food-related refuse 22 inside the upper chamber 44 of upper receptacle and then to secure the refuse 22 inside the upper chamber 44, food container 10 is provided with a removable lid 18. In the embodiment shown in FIGS. 1 through 4, lid 18 is configured to fit snugly onto upper end 46 of upper receptacle 14, such that the user pulls lid 18 off of upper receptacle 14 to access upper chamber 44 through opening 50 and pushes lid 18 onto upper receptacle 14 to close the refuse 22 inside upper chamber 44 to prevent the refuse 22 from being spilled. In a preferred embodiment, the lid 18 is hingedly attached to upper receptacle 14 so that he user does not have to have the inconvenience of holding lid 18 while he or she dispose refuse 22 inside the upper chamber 44 or risk losing lid 18 by laying it down or otherwise placing it somewhere. In the embodiment shown in FIGS. 1 through 4, lid 18 is attached to the side wall 40 of upper receptacle 14 by a flexible member 64 that allows the lid 18 to sit on top of upper receptacle 14 when closed and to lay generally along the side wall 40 of the upper receptacle 14 when the user wants access to upper chamber 44 for disposal of food-related refuse 22. FIG. 1 shows the lid 18 in its closed position and FIGS. 3 and 4 show lid 18 in its open position. In the preferred embodiment, lid 18 and the upper end 46 of upper receptacle 14 are cooperatively configured such that the lid 18 effectively snaps onto upper receptacle 14 to securely close upper chamber 44. In an alternative embodiment, shown in FIGS. 5 and 6, lid 18 is threadably attached to upper receptacle 12, with cooperating threads on the inside of lid 18 and at the upper end 46, around the opening 50, of upper receptacle 14. In this embodiment, the user unscrews the lid 18 to dispose of the refuse 22 inside upper chamber 44 and then screws lid 18 onto upper receptacle 14 to enclose the refuse inside upper chamber 44. Various other configurations of attachment mechanisms can be utilized to removably attach lid 18 to the upper receptacle 14.

If desired, the food container 10 can be utilized to provide the user with multiple types of food products 20. One configuration for such use is to provide multiple lower receptacles 12 that stack on to each other. Each of the lower receptacles 12 would be configured as described above except that they would be provided with a connecting mechanism 52 at the lower end 32 thereof to attach to the lower receptacle 12 below. The uppermost of these lower receptacles 12 would receive the upper receptacle 14 inside lower chamber 28 as described above. The other lower receptacles 12 would connect to the lower end 32 of the lower receptacle 12 immediately above. In one embodiment, each of the lower receptacles 12 would have a threaded connecting mechanism 52 that allows the below lower receptacle 12 to threadably attach to the one above. In some configurations of this embodiment, it may be necessary to move dispensing opening 38 and the dispensing mechanism 16 upward on side wall 24 so that the connection with the below lower receptacle 12 does not interfere with the user dispensing food product 20 from the lower chamber 28 of food container 10.

If desired one or more sealing members can be utilized with the food container 10 of the present invention to prevent contamination of the food product 20 and to help ensure its freshness. The sealing members can be utilized inside or over the opening 50 of lower chamber and/over tab member 58, such that the user must remove the sealing member prior to dispensing food product 20 from food container 10. In addition, a dividing member can be utilized inside the lower chamber 28 between where the bottom wall 42 of upper receptacle 14 extends when the lower 12 and upper 14 receptacles are connected and where the top of the food product 20 is located to prevent contamination of the food product by the bottom wall 42, which may be placed on the ground, a table or elsewhere.

In use, the manufacturer of food container 10 fills the lower chamber 28 with the desired food product 20 and applies the appropriate designating labels to the outer surfaces of the lower 12 and/or upper 14 receptacles. After receiving the food container 10, the user only has to perform a few steps in order to enjoy the food product in a clean, non-littering manner. The user opens the dispensing mechanism 16 to allow some food product to be shaken, poured or otherwise removed from lower chamber 28 into his or her hand or mouth. Before or after dispensing some food product, the user removes lid 18 from the upper receptacle 14 to allow access to the upper chamber 44 so that he or she may dispose of the food-related refuse 22 inside upper chamber 44. After separating the refuse 22 from the edible portion of the food product 20, the user places the refuse 22 inside upper chamber 44. When the user is done, he or she places lid 18 back onto upper receptacle 14 to enclose the refuse 22 inside the upper chamber 44 and closes the dispensing mechanism 16. In this manner, the user can move food container 10 to a different location without worrying about spilling the food product 20 or refuse 22. In the embodiment with the separatable lower 12 and upper 14 receptacles, the user can refill the lower chamber 28 with food product 20 if he or she desires and empty the refuse 22 from the upper chamber 44 when it gets full. In the embodiment where the food container 10 is intended as a single-use product (i.e., the receptacles 12/14 are fixedly joined together), then the user merely disposes of the food container 10 when the food product 20 is consumed.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A food container for packaging and serving a food product having food-related refuse, said food container comprising:
an upper receptacle having one or more side walls and a bottom wall defining an upper chamber between an upper end and a lower end of said upper receptacle, said upper end of said upper receptacle substantially open, said bottom wall of said upper receptacle closing said lower end of said upper receptacle, said upper chamber sized and configured to receive the food-related refuse therein;
a lower receptacle having one or more side walls and a bottom wall defining a lower chamber between an upper end and a lower end of said lower receptacle, said bottom wall closing said lower end of said lower receptacle, said lower chamber sized and configured to store the food product therein, said lower end of said upper receptacle received in said upper end of said lower receptacle;
a dispensing opening in at least one of said side walls or said bottom wall of said lower receptacle, said dispensing opening in communication with said lower chamber and sized and configured to allow the food product to pass therethrough;
means at said dispensing opening for selectively dispensing food product from said lower receptacle through said dispensing opening; and
a lid removably attached to said upper end of said upper chamber to selectively enclose said refuse in said upper receptacle.

2. The food container according to claim 1, wherein said lid is hingedly attached to said upper receptacle.

3. The food container according to claim 1, wherein said lid is threadably attached to said upper receptacle.

4. The food container according to claim 1, wherein said upper receptacle is removably received in said lower receptacle.

5. The food container according to claim 1, wherein said lower end of said upper receptacle is sized and configured to be tightly engaged in said upper end of said lower receptacle.

6. The food container according to claim 1 further comprising a connecting means for removably connecting said lower end of said upper receptacle to said upper end of said lower receptacle.

7. The food container according to claim 6, wherein said connecting means comprises one or more first threads at said lower end of said upper receptacle and one or more correspondingly configured second threads at said upper end of said lower receptacle.

8. The food container according to claim 1, wherein said dispensing opening is disposed in said side wall of said lower receptacle at or near said bottom wall thereof.

9. The food container according to claim 1, wherein each of said upper receptacle and said lower receptacle are generally cylindrically shaped.

10. The food container according to claim 1, wherein said dispensing means comprises a tab member hingedly attached to said side wall of said lower receptacle.

11. The food container according to claim 1, wherein said dispensing means comprises a dispensing member rotatably attached to said lower receptacle, said dispensing member having an outlet aperture configured to be placed in substantial alignment with said dispensing opening.

12. A food container for packaging and serving a food product having food-related refuse, said food container comprising:
an upper receptacle having one or more side walls and a bottom wall defining an upper chamber between an upper end and a lower end of said upper receptacle, said upper end of said upper receptacle substantially open, said bottom wall of said upper receptacle closing said lower end of said upper receptacle, said upper chamber sized and configured to receive the food-related refuse therein;
a lower receptacle having one or more side walls and a bottom wall defining a lower chamber between an upper end and a lower end of said lower receptacle, said upper end of said lower receptacle substantially open and sized and configured to removably receive said lower end of said upper receptacle therein, said bottom wall closing said lower end of said lower receptacle, said lower chamber sized and configured to store the food product therein, said lower end of said upper receptacle received in said upper end of said lower receptacle;
means for removably connecting said lower end of said upper receptacle to said upper end of said lower receptacle;
a dispensing opening in at least one of said side walls or said bottom wall of said lower receptacle, said dispensing opening in communication with said lower chamber and sized and configured to allow the food product to pass therethrough;
means at said dispensing opening for selectively dispensing food product from said lower receptacle through said dispensing opening; and
a lid removably attached to said upper end of said upper chamber to selectively enclose said refuse in said upper receptacle.

13. The food container according to claim 12, wherein said lid is hingedly attached to said upper receptacle.

14. The food container according to claim 12, wherein said lid is threadably attached to said upper receptacle.

15. The food container according to claim 12, wherein said upper receptacle is removably received in said lower receptacle.

16. The food container according to claim 12, wherein said connecting means comprises one or more first threads at said lower end of said upper receptacle and one or more correspondingly configured second threads at said upper end of said lower receptacle.

17. The food container according to claim 12, wherein said dispensing means comprises a tab member hingedly attached to said side wall of said lower receptacle.

18. The food container according to claim 12, wherein said dispensing means comprises a dispensing member rotatably attached to said lower receptacle, said dispensing member having an outlet aperture configured to be placed in substantial alignment with said dispensing opening.

19. A food container for packaging and serving a food product having food-related refuse, said food container comprising:
an upper receptacle having a side wall and a bottom wall defining an upper chamber between an upper end and a lower end of said upper receptacle, said upper end of said upper receptacle having an opening in communication with said upper chamber for access to said upper chamber, said bottom wall of said upper receptacle closing said lower end of said upper receptacle, said upper chamber sized and configured to receive the food-related refuse therein;
a lower receptacle having a side wall and a bottom wall defining a lower chamber between an upper end and a lower end of said lower receptacle, said bottom wall closing said lower end of said lower receptacle, said upper end of said lower receptacle having an opening in communication with said lower chamber for access to said lower chamber, said opening at said upper end of said lower receptacle sized and configured to removably receive said lower end of said upper receptacle therein and sealably close said lower chamber, said lower chamber sized and configured to store the food product therein, said lower end of said upper receptacle removably received in said upper end of said lower receptacle;
means for removably connecting said lower end of said upper receptacle to said upper end of said lower receptacle;
a dispensing opening in said side wall of said lower receptacle, said dispensing opening in communication with said lower chamber and sized and configured to allow the food product to pass therethrough;
means at said dispensing opening for selectively dispensing food product from said lower receptacle through said dispensing opening; and
a lid removably attached to said upper end of said upper chamber to selectively enclose said refuse in said upper receptacle.

20. The food container according to claim 19, wherein said connecting means comprises one or more first threads at said lower end of said upper receptacle and one or more correspondingly configured second threads at said upper end of said lower receptacle.
